(19) United States
(12) Patent Application Publication
(10) Pub. No.: US 2013/0146522 A1
(43) Pub. Date: Jun. 13, 2013

(54) FUEL FILTER FOR VEHICLE

(71) Applicant: Jang Hyun Jung, Suwon-si (KR)

(72) Inventor: Jang Hyun Jung, Suwon-si (KR)

(73) Assignee: Kia Motors Corp., Seoul (KR)

(21) Appl. No.: 13/487,796

(22) Filed: Jun. 4, 2012

(30) Foreign Application Priority Data
Dec. 8, 2011 (KR) 10-2011-0130845

(51) Int. Cl. B01D 29/56; B01D 29/60

(52) U.S. Cl. 210/300; 210/295

(57) ABSTRACT

A fuel filter apparatus for a vehicle may include a filter case, a first filter unit installed in the filter case and made of a hydrophilic material to increase the size of moisture droplets contained in fuel supplied, a second filter unit installed in the filter case and made of a waterproof material to allow the fuel passing through the first filter unit to pass therethrough, but restrict the moisture droplets having passed through the first filter unit from passing therethrough, and a third filter unit installed in the filter case and made of a waterproof material to allow the fuel having passed through the second filter unit to pass therethrough, but restrict the moisture droplets passing through the second filter unit from passing therethrough.

### CROSS-REFERENCE TO RELATED APPLICATIONS

The present application claims priority to Korean Patent Application No. 10-2011-0130845 filed on Dec. 8, 2011, the entire contents of which is incorporated herein for purposes by this reference.

### BACKGROUND OF THE INVENTION

1. Field of the Invention

The present invention relates, in general, to a fuel filter for a vehicle and, more particularly, to a fuel filter for a vehicle which effectively filters moisture from within bio-diesel oil or coarse fuel.

2. Description of the Related Art

Recently, as a measure against the decline in oil resources and the increase in oil prices, a diversity of alternative energies have been developed, and also in a vehicle, there is an increasing tendency to use a mixed quantity of bio-diesel oil with light-oil (conventional diesel oil).

However, since bio-diesel oil has a higher adhesive force with respect to moisture than does light-oil, a fuel filter may have lower filtering efficiency because of the moisture. If the fuel is supplied into the engine without sufficiently filtering the moisture contained in the fuel, corrosion to a variety of operating sections of a fuel system and engine is the result, weakening wear resistance and thus considerably reducing the durability of the engine and fuel system.

Such a phenomenon may also occur when course fuel is supplied, so that there is a need to more efficiently remove moisture from the bio-diesel fuel or coarse fuel.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention are directed to providing a fuel filter for a vehicle which more efficiently separates and removes moisture from bio-diesel fuel or coarse fuel, thereby securing smooth operation as well as durability of an engine and a fuel system.

In order to achieve the above object, according to one aspect of the present invention, a fuel filter apparatus for a vehicle may include a filter case, a first filter unit installed in the filter case and made of a hydrophilic material to increase the size of moisture droplets contained in fuel supplied, a second filter unit installed in the filter case and made of a waterproof material to allow the fuel passing through the first filter unit to pass therethrough, but restrict the moisture droplets having passed through the first filter unit from passing therethrough, and a third filter unit installed in the filter case and made of a waterproof material to allow the fuel having passed through the second filter unit to pass therethrough, but restrict the moisture droplets passing through the second filter unit from passing therethrough.

As previously set forth, according to an exemplary embodiment of the present invention, moisture is more efficiently separated and removed from bio-diesel fuel or coarse fuel, thereby securing smooth operation as well as the durability of an engine and a fuel system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the external appearance of a fuel filter for a vehicle according to an exemplary embodiment of the present invention.

FIG. 2 is a cross-sectional view showing the internal structure of the fuel filter shown in FIG. 1.

FIG. 3 is an exploded perspective view showing the fuel filter shown in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

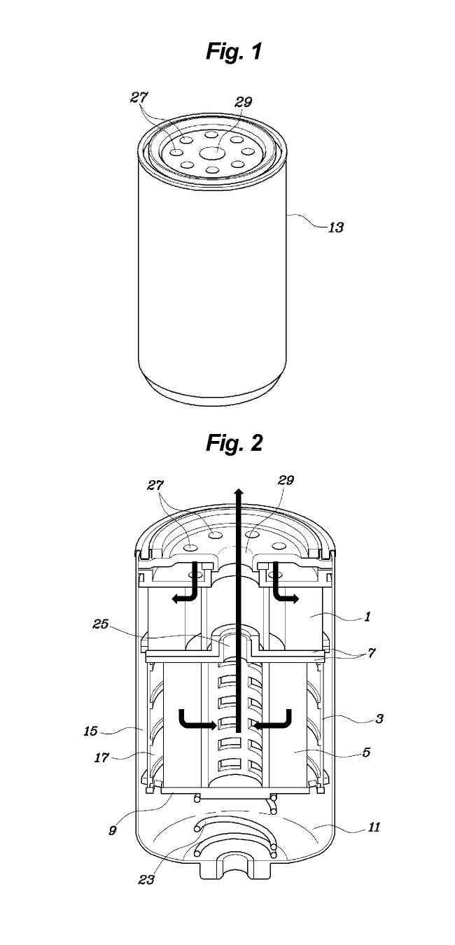

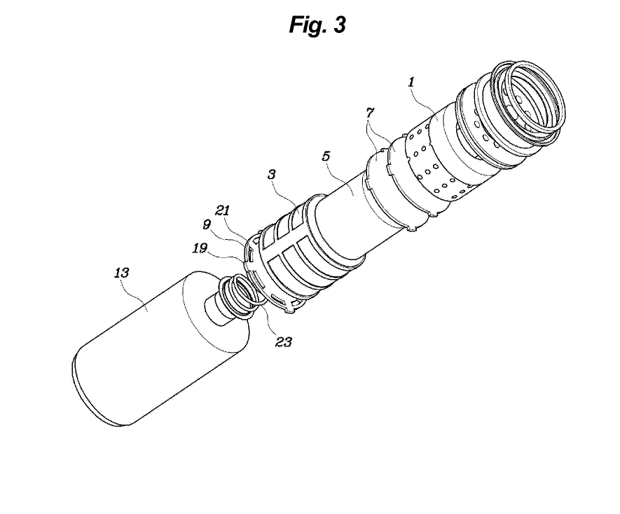

Referring to FIGS. 1 to 3, a fuel filter for a vehicle according to an exemplary embodiment of the present invention includes a first filter unit 1 made of a hydrophilic material to increase the size of moisture droplets contained in fuel supplied, a second filter unit 3 made of a waterproof material to allow the fuel passing through the first filter unit 1 to pass therethrough, yet restricting the moisture that has passed through the first filter unit 1 from passing therethrough, and a third filter unit 5 made of a waterproof material to allow the fuel that has passed through the second filter unit 3 to pass therethrough, but restricting the moisture passing through the second filter unit 3 from passing therethrough.

The fuel that is supplied to the fuel filter successively passes through the first hydrophilic filter unit 1 and the second and third waterproof filter units 3 and 5. Here, the first filter unit increases the size of moisture droplets because the hydrophilic material of the first filter unit has a tendency to interact with moisture, helping to separate the moisture from the fuel. Here, the fuel successively passes through the second and third waterproof filter units 3 and 5, so that moisture contained in the fuel is easily and efficiently separated from the fuel.

The second filter unit 3 is installed downstream of the first filter unit 1 with a first baffle plate 7 disposed therebetween, so that the fuel having passed through the first filter unit 1 continues downstream of the first filter unit 1 through the first baffle plate 7, and passes horizontally through the second filter unit 3.

The third filter unit 5 is installed at the same level as the second filter unit 3 such that the fuel having passed through the second filter unit 3 passes horizontally therethrough.

The second and third filter units 3 and 5 are horizontally disposed downstream the first filter unit 1 such that moisture contained in fuel having passed through the first filter unit 1 flows first down and then horizontally, so that the size of the moisture droplets at the first filter unit is easily separated from the fuel while passing through the second and third filter units 3 and 5, allowing only pure fuel to pass through the second and third filter units.

The third filter unit 5 is installed at a distance from the second filter unit 3 in order to additionally separate moisture that is not filtered by the second filter unit 3.

A water storage 11 is provided downstream of the second and third filter units 3 and 5, with a second baffle plate 9 disposed therebetween, in order to store the moisture separated from the fuel and discharge the same.

The first filter unit 1 includes a hydrophilic filtering member having the shape of a hollow doughnut so that the fuel can horizontally flow from the inside to outside of the first filter unit. The second filter unit 3 includes a waterproof network having the shape of a hollow pipe, and is installed around the third filter unit 5. The third filter unit 5 includes a waterproof filtering member having the shape of a hollow doughnut so that the fuel can horizontally flow from the outside to the inside of the third filter unit.

The first filter unit 1 and the second filter unit 3 are received in a filter case 13 such that a passage is formed between the first baffle plate 7 and the filter case 13, through which moisture contained fuel flows downwards, and such that a first water passage 15 is formed between the second filter unit 3 and the filter case 13, through which water obtained by the gathering of moisture as it passes through the first filter unit 1 is separated and flows down into the water storage 11, while only pure fuel horizontally flows towards the second and third filter units.

A second water passage 17 is formed between the second and third filter units 3 and 5 to allow the moisture filtered by the second filter unit 3 to be flow therethrough, while only pure fuel passes through the third filter unit 5. The second baffle plate 9 is provided with drain protrusions 19 and drain holes 21. The drain protrusions form passages with respect to the filter case 13, through which the moisture flowing through the first water passage 15 is drained into water storage 11. The moisture flowing through the second water passage 17 drains through the drain holes into the water storage 11.

A support spring 23 is installed between the second baffle plate 9 and the filter case 13 to elastically support the second baffle plate 9 with respect to the filter case 13. Consequently, the elastic force of the support spring 23 has an influence on the second and third filter units 3 and 5 and up to the first filter unit 1 via the first baffle plate 7, so that parts installed in the filter case 13 are kept undamaged and sealed by the action of elastic force.

According to the fuel filter constructed as described before, as indicated by an arrow in FIG. 2, the moisture droplets contained in the fuel introduced into an inlet 27 from the upside gather together to considerably increase in size while passing through the first hydrophilic filter unit 1, making it easy for them to be separated from the fuel. The fuel successively horizontally passes through the second and third waterproof filter units 3 and 5, so that the moisture separated from the fuel is completely drained into the water storage 11, and the completely filtered fuel while passing through the third filter unit 5 flows upwards through a central core passage 25 and out of an outlet 29, and finally to the engine.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel filter apparatus for a vehicle comprising:
a filter case;
a first filter unit installed in the filter case and made of a hydrophilic material to increase the size of moisture droplets contained in fuel supplied;
a second filter unit installed in the filter case and made of a waterproof material to allow the fuel passing through the first filter unit to pass therethrough, but restrict the moisture droplets having passed through the first filter unit from passing therethrough; and
a third filter unit installed in the filter case and made of a waterproof material to allow the fuel having passed through the second filter unit to pass therethrough, but restrict the moisture droplets passing through the second filter unit from passing therethrough.

2. The fuel filter apparatus according to claim 1, wherein the second filter unit is installed downstream of the first filter unit with a first baffle plate disposed therebetween in the filter case, so that the fuel having passed through the first filter unit passes downstream of the first filter unit through the first baffle plate, and then passes through the second filter unit in a horizontal direction.

3. The fuel filter apparatus according to claim 2, wherein the third filter unit is installed at the same level as the second filter unit such that the fuel having passed through the second filter unit passes therethrough in a horizontal direction, and wherein a water storage is provided downstream of the second and third filter units, with a second baffle plate disposed therebetween, to store the moisture droplets separated from the fuel and discharge the same.

4. The fuel filter apparatus according to claim 3, wherein the second filter unit is spaced from the third filter unit with a gap.

5. The fuel filter apparatus according to claim 3, wherein the first filter unit includes a hydrophilic filtering member shaped like a hollow doughnut so that the fuel horizontally flows from the inside to outside of the first filter unit, wherein the second filter unit includes a waterproof network shaped like a hollow pipe, and is installed around the third filter unit, and wherein the third filter unit includes a waterproof filtering member shaped like a hollow doughnut so that the fuel horizontally flows from the outside to inside of the third filter unit through the second filter unit.

6. The fuel filter apparatus according to claim 5,
wherein the first filter unit and the second filter unit are received in the filter case in series along a longitudinal axis of the filter case, and
wherein a passage is formed between the first baffle plate and the filter case, through which moisture droplets contained in fuel flow downwards, and
wherein a first water passage is formed between the second filter unit and the filter case, so that water obtained as the fuel passes through the first filter unit is separated and flows down into the water storage, while filtered fuel horizontally flows towards the second and third filter units.

7. The fuel filter apparatus according to claim 6, wherein the filtered fuel in the third filter unit flow out of the filter case through a passage formed along center axes of the third filter unit and the first filter unit in a sequence.

8. The fuel filter apparatus according to claim 6, wherein a second water passage is formed between the second and third filter units to allow the moisture droplets filtered by the second filter unit to flow therethrough to the water storage, and while the filtered fuel passes through the third filter unit, wherein the second baffle plate is provided with drain protrusions and drain holes

9. The fuel filter apparatus according to claim 8,
wherein the drain protrusions form the first water passages therebetween with the filter case, and the moisture droplets formed in the first water passage are drained into the water storage, and
wherein the drain holes disposed between the second filter unit and the third filter unit to drain the moisture flowing through the second water passage into the water storage.

10. The fuel filter apparatus according to claim 8, wherein a support spring is installed between the second baffle plate and the filter case to elastically support the second baffle plate with respect to the filter case.

11. The fuel filter apparatus according to claim 1, wherein the second and third filter units are horizontally disposed at the downstream of the first filter unit such that moisture droplets contained fuel passed through the first filter unit flow first down and then horizontally, wherein the third filter unit is installed at a distance from the second filter unit in order to additionally separate moisture that is not filtered by the second filter unit.
